(19) United States
(12) Patent Application Publication
(10) Pub. No.: US 2024/0019067 A1
(43) Pub. Date: Jan. 18, 2024

(54) WATER HAMMER PREVENTION DEVICE FOR BOILER

(71) Applicant: KOFULSO CO., LTD., lncheon-si (KR)

(72) Inventor: Seung-il OH, Seoul (KR)

(73) Assignee: KOFULSO CO., LTD., lncheon-si (KR)

(21) Appl. No.: 17/947,343

(22) Filed: Sep. 19, 2022

(30) Foreign Application Priority Data
Jul. 15, 2022 (KR) 10-2022-0087321

(51) Int. Cl. F16L 55/04; F16L 55/055

(52) U.S. Cl. CPC F16L 55/043; F16L 55/055

(57) ABSTRACT

A water hammer prevention device for a boiler includes: a housing; a joint coupled to the housing for water flow; a water hammer prevention part to which water pressure introduced through the joint is applied and wherein the water hammer prevention means is a flexible displacement member, including a coupling part formed between the first and second members of the housing to be fastened; an inclined part formed inclined downwardly from the coupling part and the water hammer displacement part upwardly protruding from the inclined part, and an elastic member mounted between the lower surface of the water hammer displacement part and the second member to provide a restoring force.

### BACKGROUND OF THE INVENTION

### Field of the Invention

The present invention relates to a water hammer prevention device for a boiler, and more specifically, to a water hammer prevention device for a boiler, which is installed on a hot and cold water supply line or a valve of a boiler to absorb shock waves generated by a sudden water pressure change.

### Background Art

The water hammer phenomenon caused by a sudden change in hydraulic pressure generated when a valve is opened and closed in a hot and cold water supply line of a boiler causes noise and vibration since shock waves are transferred to a pipe. Such noise and vibration may damage the pipe and the boiler as well as cause anxiety.

FIGS. 1 and 2 are views illustrating a conventional pressure absorbing device disclosed in U.S. Pat. No. 9,777,880 to prevent the water hammer phenomenon occurring in a hot and cold water supply line of a boiler.

FIG. 1 is a view illustrating a water hammer prevention device having a flexible diaphragm 2-1, which absorbs shock waves while being pushed to one space by a pressure difference generated when a flow of water flowing into a housing 1 is rapidly changed so as to prevent the water hammer phenomenon.

The conventional pressure absorbing device can reduce problems caused by the water hammer phenomenon, but the capacity of absorbing shock waves is reduced as time goes by. Especially, the outer edge or inner part of the diaphragm 2-1 is frequently weakened or damaged.

FIG. 2 is a view showing a water hammer prevention device having a membrane hollow member 2-2 having a hollow part therein so as to absorb shock waves while the membrane hollow member 2-2 is pressed, illustrating the membrane hollow member 2-2 of a spherical ball having the hollow part therein.

The membrane hollow member 2-2 is superior to the diaphragm 2-1 in durability. However, compared with the diaphragm 2-1, the membrane hollow member 2-2 is difficult to manufacture, and is increased in size since the housing 1 determining the size of the water hammer prevention device must accommodate the spherical ball shaped membrane hollow member 2-2 having the hollow part.

### SUMMARY OF THE INVENTION

Accordingly, the present invention has been made to solve the above-mentioned problems occurring in the prior arts, and it is an object of the present invention to provide a water hammer prevention device for a boiler having a flexible displacement member of a new structure as a water hammer prevention means, which can form a housing in a small size like the diaphragm which is the conventional water hammer prevention means, can be easily manufactured, can provide excellent durability, which is the advantage of the membrane hollow member, and can quickly respond to a sudden pressure change.

Another object of the present invention is to provide a water hammer prevention device for a boiler, which includes a joint member, a housing having first and second members, and a flexible displacement member, as a water hammer prevention means, accommodated inside a space of the housing by sequential processes, thereby facilitating mass production.

To accomplish the above object, according to the present invention, there is provided a water hammer prevention device for a boiler including: a housing; a joint coupled to the housing to allow water to flow into the housing; and a water hammer prevention means to which pressure of water introduced through the joint is applied, wherein the water hammer prevention means is a flexible displacement member, which includes: a coupling part formed between the first and second members of the housing to be fastened; an inclined part formed to be inclined downward from the coupling part; and a displacement part upwardly protruding from the inclined part, and an elastic member is mounted between the lower surface of the displacement part and the second member to provide a restoring force to the displacement part.

In another aspect of the present invention, the joint includes: an insertion part formed at a lower portion of the joint and inserted into a protrusion part of the first member; a packing and a washer sequentially inserted into the insertion part; and a first bent part formed by the insertion part bent outward for fixing the joint to the first member in a state in which the packing is compressed to the inner surface of the protrusion part, and the first member includes a second bent part for coupling the coupling part to be compressed between the first and second members in a state in which the coupling part of the displacement member and an edge part of the second member are sequentially inserted into an edge part of the first member.

According to the present invention, shock waves introduced into the housing through the joint and transferred to the flexible displacement member, which is the water hammer prevention means, displaces only the displacement part to which a restoring force is applied by the elastic force and the elastic member. Therefore, the water hammer prevention device for a boiler according to the present invention can rapidly absorb shock waves causing the water hammer, prevent a damage of the flexible displacement member including the coupling part and the inclined part, and allow the joint and the first and second members to be efficiently assembled by a series of sequential processes, thereby increasing productivity.

### BRIEF DESCRIPTION OF THE DRAWINGS

The above and other objects, features and advantages of the present invention will be apparent from the following detailed description of the preferred embodiments of the invention in conjunction with the accompanying drawings, in which:

FIG. 1 is a block diagram of a conventional water hammer prevention device;

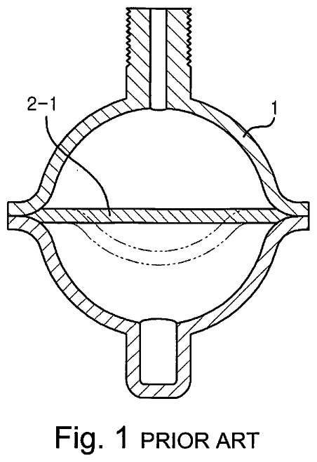

FIG. 2 is a block diagram of another conventional water hammer prevention device;

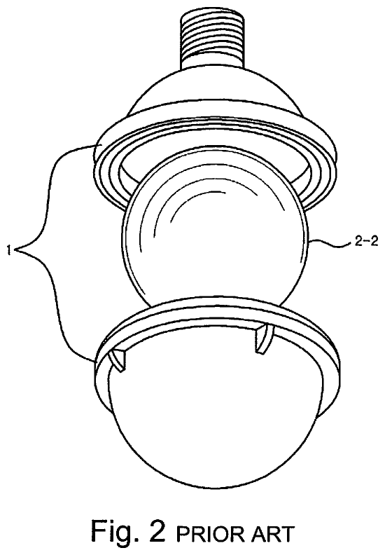

FIG. 3 is an exploded perspective view of a water hammer prevention device for a boiler according to an embodiment of the present invention;

FIG. 4 is a cross-sectional view illustrating a combined state of the water hammer prevention device for a boiler according to the embodiment of the present invention; and

FIG. 5 is a view illustrating a coupled state of a joint and a first member.

### DETAILED DESCRIPTION OF THE INVENTION

The present invention will be described in detail with reference to the accompanying drawings.

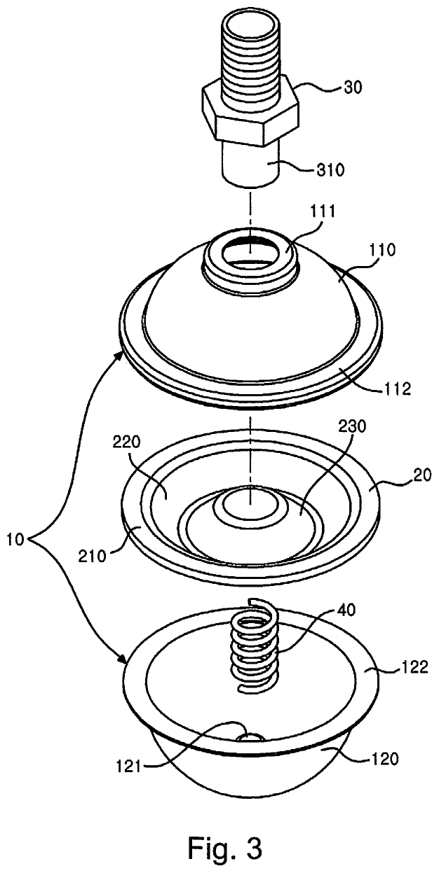

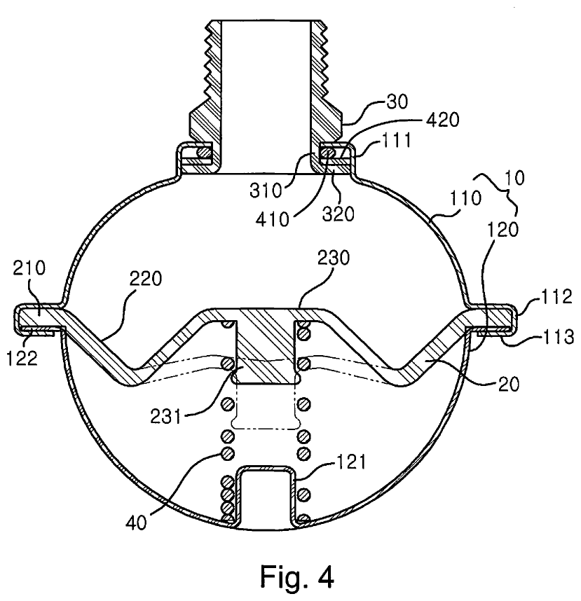

As illustrated in FIGS. 3 and 4, a water hammer prevention device for a boiler according to an embodiment of the present invention includes: a housing 10; a joint 30 coupled to the housing 10 to allow water to flow into the housing 10; and a water hammer prevention means to which pressure of water introduced through the joint 30 is applied.

The housing 10 includes first and second members 110 and 120, which are coupled to each other so as to form an internal space so that water flows through a water supply line and shock waves can be transferred to the water hammer prevention means.

The water hammer prevention means is a flexible displacement member 20, which includes: a coupling part 210 formed between the first and second members 110 and 120 of the housing 10 to be fastened; an inclined part 220 formed to be inclined downward from the coupling part 210; and a displacement part 230 upwardly protruding from the inclined part 220.

An elastic member 40 is mounted between the lower surface of the displacement part 230 and the second member 120 to provide a restoring force to the displacement part 230.

When the displacement part 230 is pressed down by an external force and the external force is removed, the displacement part 230 is rapidly restored to its original state by self-restoring force and the restoring force of the elastic member 40.

The elastic member 40 may be a coil spring as illustrated in FIG. 4, but the embodiment of the present invention is not limited to the coil spring.

In a case in which the elastic member 40 is a coil spring, fitting parts 231 and 121 (FIG. 4) to which the coil spring is forcedly fitted on protrude from the lower portions of the second member 120 and the displacement part 230 to face each other.

As illustrated in FIG. 4, the joint 30 includes: an insertion part 310 formed at a lower portion of the joint and inserted into a protrusion part 111 of the first member 110; a packing 410 and a washer 420 sequentially inserted into the insertion part 310; and a first bent part 320 formed by the insertion part 310 bent outward for fixing the joint 30 to the first member 110 in a state in which the packing 410 is compressed to the inner surface of the protrusion part 111. The first member 110 includes a second bent part 113 for coupling the coupling part 210 to be compressed between the first and second members 110 and 120 in a state in which the coupling part 210 of the displacement member 20 and an edge part 122 of the second member 120 are sequentially inserted into an edge part 112 of the first member 110.

The joint 30 coupled to a water supply line is mounted on the first member 110 of the housing 10 to be fixed by the first bent part 320 which bends and compresses the insertion part 310 outward.

In a case in which only the compression force of the first bent part 320 cannot prevent rotation of the joint 30, the first bent part 320 may be fixed to two positions of the protrusion part 111 by spot welding.

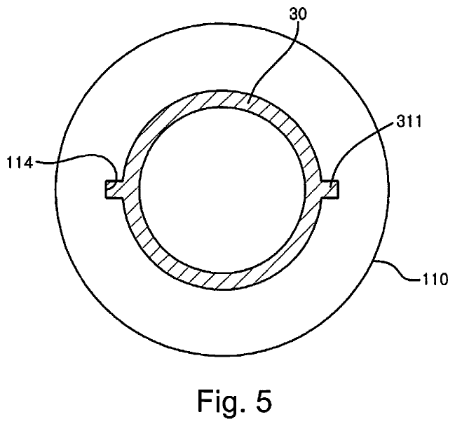

In addition, as illustrated in FIG. 5, the first member 110 has a retaining groove 114 formed at an insertion portion, and the joint 30 has a retained part 311 formed at the insertion part 310 thereof so as to prevent rotation of the joint 30.

The first member 110 and the second member 120 coupled with the joint 30 are coupled to each other in the state in which the coupling part 210 is compressed by the second bent part 113, thereby completing the manufacture of the water hammer prevention device for a boiler according to the present invention.

The packing 410 made of a resilient material, such as rubber, and the coupling part 210 of the displacement member 20 serve to seal the inner space of the housing 10 in the compressed state.

The joint 30 according to the present invention is coupled to a water supply line of the boiler or mounted at an inlet side of a three-way valve through which water is drained.

The rapid shock waves of water introduced into the first member 110 through the joint 30 is absorbed by the convex displacement part 230 of the displacement member 20, thereby preventing the water hammer phenomenon.

Water pressure does not act on the coupling part 210 and the inclined part 220 when the displacement part 230 is displaced, and the elastic member 40 is compressed according to the displacement of the displacement part 230 to absorb the shock waves with the restoring force of the displacement part 230 according to a sudden flow change, and to provide a restoring force to recover the displacement part 230 to its original state.

As described above, since the housing 10 is manufactured to have a size corresponding to a space in which the displacement part 230 of the displacement member 20 is displaced, the water hammer prevention device for a boiler according to the present invention can be manufactured in a small size compared with the conventional membrane hollow member 2-2 of the spherical ball shape. Moreover, the inclined part 220 formed to displace only the displacement part 230 reduces pressure applied to the coupling part 210 in order to semipermanently maintain the lifespan of the water hammer prevention device. The water hammer prevention device for a boiler according to the present invention can absorb greater shock waves by the elastic member 40 and rapidly restore the displacement part 230, and assemble the housing 10 and the joint 20 by sequential processes suitable for mass production to be sealed perfectly, thereby improving productivity.

Although the present invention has been described in detail with reference to the accompanying drawings, it is to be understood that various changes may be made therein without departing from the spirit and scope of the present invention.

1. A water hammer prevention device for a boiler comprising:
a housing; a joint coupled to the housing to allow water to flow into the housing; and a water hammer prevention displacement to which pressure of water introduced through the joint is applied;
wherein the water hammer prevention displacement part is a flexible displacement member, which includes: a coupling part formed between the first and second members of the housing to be fastened; an inclined part formed to be inclined downward from the coupling part; and the water hammer prevention displacement part upwardly protruding from the inclined part, and an elastic member is mounted between the lower surface of the displacement part and the second member to provide a restoring force to the water hammer prevention displacement part.

2. The water hammer prevention device according to claim 1, wherein the elastic member is a coil spring, and fitting parts to which the coil spring is forcedly fitted protrude from the lower portions of the second member and the water hammer prevention displacement part to face each other.

3. The water hammer prevention device according to claim 1, wherein the joint includes an insertion part formed at a lower portion of the joint and inserted into a protrusion part of the first member; a packing and a washer sequentially inserted into the insertion part; and a first bent part formed by the insertion part bent outward for fixing the joint to the first member in a state in which the packing is compressed to an inner surface of the protrusion part, and the first member includes a second bent part for coupling the coupling part to be compressed between the first and second members in a state in which the coupling part of the water hammer prevention displacement member and an edge part of the second member are sequentially inserted into an edge part of the first member.

4. The water hammer prevention device according to claim 3, wherein the first bent part is fixed to two positions of the protrusion part by spot welding.

5. The water hammer prevention device according to claim 3, wherein the first member has a retaining groove formed at an insertion portion, and the joint has a retained part formed at the insertion part thereof.
